(19) United States
(12) Patent Application Publication
(10) Pub. No.: US 2002/0147029 A1
(43) Pub. Date: Oct. 10, 2002

(54) Mobile phone

(76) Inventor: Chung-Wei Wu, Taipei (TW)

Correspondence Address: VOLPE AND KOENIG, P.C., SUITE 400, ONE PENN CENTER, 1617 JOHN F. KENNEDY BOULEVARD, PHILADELPHIA, PA, 19103, US

(21) Appl. No.: 09/828,754

(22) Filed: Apr. 9, 2001

(51) Int. Cl. H04M 1/00

(52) U.S. Cl. 455/558; 455/556

(57) ABSTRACT

A mobile phone capable of being activated by a signal transmitted from an activation device is provided. The mobile phone includes an IC card driver connected with a communication system for communicating with others, and an access module connected with the IC card driver and the communication system for receiving the signal transmitted from the activation device to activate the mobile phone, thereby communicating with others.

### FIELD OF THE INVENTION

The present invention relates to a mobile phone, and more particularly to a mobile phone activated by a signal transmitted from an activation device.

### BACKGROUND OF THE INVENTION

Nowadays, mobile phones are popular communication devices. It is very convenient that people can transmit connections to anyone with mobile phones at any place all the time.

In the present day, an IC card, e.g. a Subscriber Identity Module (SIM) card is adapted to a mobile phone for identification. The IC card should be installed and in contact with electronic components in the mobile phone.

Please refer to FIG. 1. FIG. 1 is a schematic view showing a conventional mobile phone combined with an IC card. An IC card 5 is installed in a mobile phone 2 by a user 1. Then, an IC card driver 3 accesses database recorded in the IC card 5 through an access module 4 to activate communications.

It is inconvenient to extract and replace the IC card in the mobile phone. Moreover, if the user loses the mobile phone, the user also loses the IC card.

In order to overcome the problems described above, the present invention provides a mobile phone which is not combined with an IC card and activated by a signal transmitted from an activation device.

### SUMMARY OF THE INVENTION

It is an object of the present invention to provide a mobile phone capable of being activated by a signal transmitted from an activation device.

In accordance with the present invention, the mobile phone comprises an IC card driver connected with a communication system for communicating with others, and an access module connected with the IC card driver and the communication system for receiving the signal transmitted from the activation device to activate the mobile phone, thereby communicating with said others.

In addition, the activation device comprises an integrated circuit (IC) card and a transmitter. The IC card records an identification data for being recognized by the access module.

The transmitting device automatically detects a distance between the activation device and the mobile phone, and when the activation device approaches the mobile phone in a specific distance, the signal is transmitted from the activation device to activate the communication system to get communication with others.

Furthermore, when the activation device is carried on a user and the user is approaching the mobile phone in the specific distance, the communication system is activated by the activation device.

Certainly, the mobile phone could be used in a vehicle. The mobile phone is combined with an audio in the vehicle.

In accordance with the present invention, when the access module detects the signal transmitted from the activation device, the IC card driver activates the communication system.

The present invention may best be understood through the following descriptions with reference to the accompanying drawings, in which:

### BRIEF DESCRIPTION OF THE DRAWINGS

FIG. 1 is a schematic block view showing a conventional mobile phone combined with an IC card according to the prior art; and

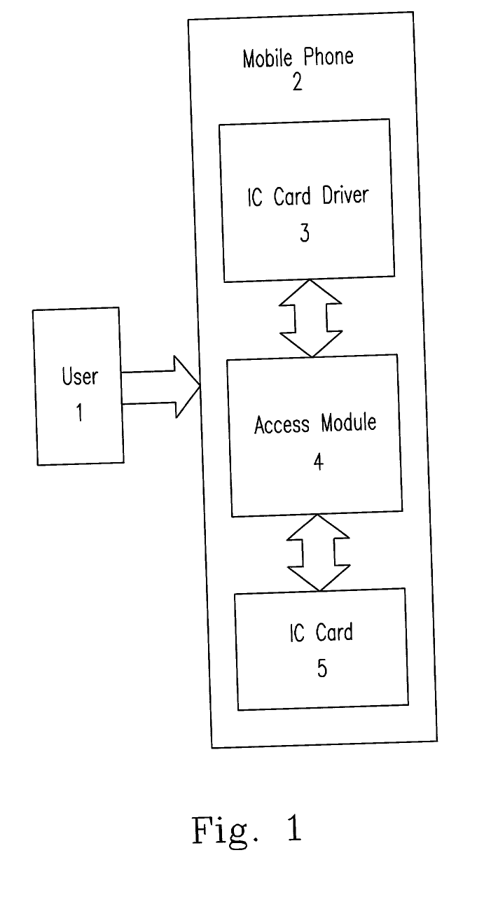

FIG. 2 is a schematic block view showing a mobile phone according to the preferred embodiment of the present invention.

### DETAILED DESCRIPTION OF THE PREFERRED EMBODIMENTS

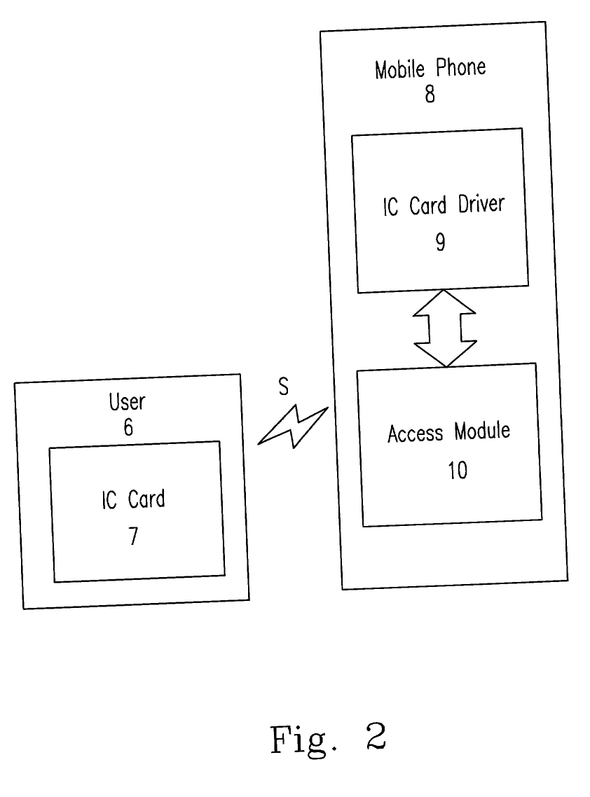

Please refer to FIG. 2. An IC card driver 9 and an access module 10 are installed in a mobile phone 8. When an IC card 7 carried on an user 6 is approached the mobile phone 8 in a specific distance, a signal S transmitted from the IC card 7 is detected by the access module 10, and then the IC card driver 9 accesses database recorded in the IC card 7 through the access module 10 to activate a communication.

Certainly, the IC card 7 could be integrated with a transmitter in an activation device. The mobile phone 8 could be activated by the activation device.

In addition, the IC card driver 9 shown in FIG. 2 should be modified according to the access module 10.

The mobile phone provide by the present invention is not combined with an IC card. When the IC card carried on an user is approached the mobile phone provided by the present invention in the specific distance, the communication system is activated.

In addition, the mobile phone provided by the present invention could be used in a vehicle, even combined with a audio in the vehicle. Only when the user carries the IC card approached the mobile phone in the specific distance, the communication system could be activated.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A mobile phone capable of being activated by a signal transmitted from an activation device, comprising:
an IC card driver connected with a communication system for communicating with others; and
an access module connected with said IC card driver and said communication system for receiving said signal transmitted from said activation device to activate said mobile phone, thereby communicating with said others.

2. The mobile phone according to claim 1, wherein said activation device comprises an integrated circuit (IC) card and a transmitter.

3. The mobile phone according to claim 2, wherein said IC card records an identification data for being recognized by said access module.

4. The mobile phone according to claim 2, wherein said transmitting device automatically detects a distance between said activation device and said mobile phone, and when said activation device approaches said mobile phone in a specific distance, said signal is transmitted from said activation device to activate said communication system to get communication with said others.

5. The mobile phone according claim 1, wherein when said activation device is carried on a user and said user is approaching said mobile phone in said specific distance, said communication system is activated by said activation device.

6. The mobile phone according to claim 5, wherein said mobile phone is used in a vehicle.

7. The mobile phone according to claim 6, wherein said mobile phone is combined with an audio in said vehicle.

8. The mobile phone according to claim 1, wherein when said access module detects said signal transmitted from said activation device, said IC card driver activates said communication system.
